(19) United States
(12) Patent Application Publication
(10) Pub. No.: US 2010/0245021 A1
(43) Pub. Date: Sep. 30, 2010

(54) Thermal overload relay

(75) Inventors: Yukinari Furuhata, Konosu-shi (JP); Fumihiro Morishita, Konosu-shi (JP); Takeo Kamosaki, Konosu-shi (JP)

Correspondence Address: KANESAKA BERNER AND PARTNERS LLP, 1700 DIAGONAL RD, SUITE 310, ALEXANDRIA, VA, 22314-2848, US

(73) Assignee: FUJI ELECTRIC FA COMPONENTS & SYSTEMS CO., LTD., Tokyo (JP)

(21) Appl. No.: 12/659,005

(22) Filed: Feb. 23, 2010

(30) Foreign Application Priority Data
Mar. 27, 2009 (JP) 2009-079398

(51) Int. Cl. H01H 71/16

(52) U.S. Cl. 337/112

(57) ABSTRACT

A thermal overload relay has an actuator mechanism that generates an operating force by bending of a main bimetal with a heating wire wound thereon; a switching mechanism that is driven by the operating force from the actuator mechanism; a contact changeover mechanism wherein contacts are changed by the switching mechanism operation; and a casing that contains the actuator, the switching and the contact changeover mechanisms. The casing has main circuit terminals and auxiliary circuit terminals arranged on one side, the main circuit terminals electrically connecting the thermal overload relay to an electric load device, and the auxiliary circuit terminals electrically connecting the thermal overload relay to another electric device. When the casing is viewed in plan, the main circuit terminals are aligned and, the auxiliary circuit terminals are arranged in a position offset from the position of the alignment of the main circuit terminals.

### BACKGROUND OF THE INVENTION AND RELATED ART STATEMENT

The present invention relates to a thermal overload relay carrying out switching of contacts when an overcurrent is detected and particularly to an improvement of a casing of a thermal overload relay containing an actuator mechanism, a switching mechanism and a contact changeover mechanism.

A thermal overload relay has a casing containing therein an actuator mechanism provided with bimetals each having a heating wire (heater) wound thereon, a shifter engaged with each of the open ends of the bimetals to be supported movably in the horizontal direction, a switching mechanism linked with a shifter to be operated by the shift of the shifter and a contact changeover mechanism carrying out changeover of contacts by the operation of the switching mechanism (see JP-A-2004-172122, for example).

Such a thermal overload relay is an electric device that is connected with an electromagnetic contactor to thereby form an electromagnetic switch, makes the electromagnetic switch connected between an electric load device such as a motor and a power supply, disconnect the electric circuit between the motor and the power supply when an overcurrent is caused in which a current energizing the motor exceeds a predetermined current value, and prevents the motor from being damaged.

FIG. 9 is a plan view showing an external appearance of a related thermal overload relay. In FIG. 9, on the upper face of a casing 50 with an approximately cubic shape, there are disposed an adjusting dial 51 for adjusting a stabilized current and a resetting rod 52 for resetting a contact mechanism. On the one side of the casing 50, load side main circuit terminals 53 are provided which are connected to an electrical load device. Along with this, from the other side of the casing 50, there protrude three of an R-phase power supply side terminal 54R, an S-phase power supply side terminal 54S and a T-phase power supply side terminal 54T which are connected to an electromagnetic contactor. Here, an R-phase terminal 53R, an S-phase terminal 53S and a T-phase terminal 53T forming the load side main circuit terminals 53, are arranged in line at the same height.

On one side of the casing 50 provided with the load side main circuit terminals 53, there are provided first auxiliary circuit terminals b1 and b2 with normally closed contacts and second auxiliary circuit terminals a1 and a2 with normally open contacts all having the same terminal screw sizes as those of the load side main circuit terminals 53. The first auxiliary circuit terminal b1 and the second auxiliary circuit terminal a1 are made positioned on the same line as that of the load side main circuit terminals 53 (the R-phase terminal 53R, S-phase terminal 53S and T-phase terminal 53T). The remaining first auxiliary circuit terminal b1 and the second auxiliary circuit terminal a2 are provided at positions ahead of and lower than those of the load side main circuit terminals 53.

Normally, the first auxiliary circuit terminals b1 and b2 with normally closed contacts are provided so as to be electrically connected to terminals on the side of an electromagnetic coil of an electromagnetic contactor connected to the thermal overload relay and the second auxiliary circuit terminals a1 and a2 with normally open contacts are provided so as to be electrically connected to a means such as an alarm device notifying an abnormality by lighting up a lamp.

[Patent Document 1] JP-A-2004-172122

Such a thermal overload relay is normally used by mounting it on a wall. However, the thermal overload relay mounted on a wall, when viewed from the upper face side of the casing 50 as shown in FIG. 9, has the R-phase terminal 53R, S-phase terminal 53S and T-phase terminal 53S forming the load side main circuit terminals 53 and the first auxiliary circuit terminal b1 and the second auxiliary circuit terminal a1 positioned on the same line. This may cause improper wiring when a three-phase motor is connected to the thermal overload relay.

Moreover, the frequency of using the first auxiliary circuit terminals b1 and b2 electrically connected to an electromagnetic contactor is more than that of using the second auxiliary circuit terminals a1 and a2. However, the first auxiliary circuit terminal b2 as one of the pair of the first auxiliary circuit terminals b1 and b2 is positioned on the wall side. Thus, there is a problem that the work of electrical connection with the electromagnetic contactor takes a lot of time.

Furthermore, within the casing 50, there are provided three heat element containing spaces in which three bimetals of an actuator mechanism for the R-, S- and T-phases, respectively, in a three-phase system are contained isolatedly from one another, and a contact switching mechanism containing space in which a switching mechanism and a contact changeover mechanism are contained. The casing 50, however, when the thermal overload relay is to be made downsized, causes the heating by a heating wire in the heat element containing space for the S-phase, positioned between the heat element containing space for the R-phase and that for the T-phase, to be thermally affected by the heating by the heating wires in the other heat element containing spaces to result in an increase in an amount of heating in the heating element containing space for the S-phase. To counter this, there is proposal of setting the heating capacity smaller with respect to the heating wire in the heat element containing space for the S-phase. This, however, results in increase in special process control in manufacturing the thermal overload relay to be problems in heating wire mounting work and in manufacturing cost.

Accordingly, the invention was made with attention given to the unsolved problems in the above-explained related thermal overload relay with an object of providing a thermal overload relay that facilitates work of electrical connection with an electric load device and an electromagnetic contactor and, along with this, is thermally unaffected by the heating wires even though the relay is to be made downsized to make it possible to facilitate the heating wire mounting work and to reduce the manufacturing cost.

Further objects and advantages of the invention will be apparent from the following description of the invention.

### SUMMARY OF THE INVENTION

In order to achieve the above object, the thermal overload relay according to the invention includes an actuator mechanism that generates an operating force by bending of a main bimetal (with a heating wire wound thereon) in response to a temperature rise in the main bimetal; a switching mechanism that is driven by the operating force from the actuator mechanism; a contact changeover mechanism with its contacts changed over by the operation of the switching mechanism; and a casing that contains the actuator mechanism, the switching mechanism and the contact changeover mechanism. The casing has main circuit terminals and auxiliary circuit terminals arranged on one side, the main circuit terminals electrically connecting the thermal overload relay to an electric load device, and the auxiliary circuit terminals electrically connecting the thermal overload relay to another electric device. When the casing is viewed from its upper face cover side, the main circuit terminals are aligned and, along with this, the auxiliary circuit terminals are arranged in a position different from the alignment of the main circuit terminals.

According to the invention, the upper face cover of the thermal overload relay mounted on a wall faces a worker carrying out wiring work that connects the thermal overload relay to an electric load device. In this state, the auxiliary circuit terminals are arranged in positions different from the positions of the aligned main circuit terminals. Therefore, a distinction in visual angle is clearly established between the circuits of the main circuit terminals and the circuits of the auxiliary circuit terminals.

Moreover, in the thermal overload relay according to the invention, the auxiliary circuit terminals are formed of first auxiliary circuit terminals with normally closed contacts and second auxiliary circuit terminals with normally open contacts. When the casing is viewed from the side, the first auxiliary circuit terminals with normally closed contacts are arranged in upper positions with respect to the positions of the second auxiliary circuit terminals with normally open contacts.

According to the invention, the first auxiliary circuit' terminals with higher frequency of being used for connection with a device such as an electromagnetic contactor are at positions on the side of a worker (on the front side) with respect to the positions of the second auxiliary circuit terminals. This facilitates the connection work on the first auxiliary circuit terminals compared with the connection work at the related thermal overload relay.

In addition, the thermal overload relay according to the invention has on the upper face cover of the casing, an auxiliary circuit terminal display formed in the vicinity of the auxiliary circuit terminals, for indicating the terminal types and positions of the auxiliary circuit terminals.

According to the invention, a worker can perform precise connection work between a specified wire and a terminal while observing the auxiliary circuit terminal display on the upper face cover of the casing.

Moreover, the thermal overload relay according to the invention is, within the casing, provided with a heat element containing space for containing the actuator mechanism having the main bimetal with a heating wire wound thereon, and a contact switching mechanism containing space containing the switching mechanism and the contact changeover mechanism. The thermal overload relay is further provided with vents on both of the side faces of the casing for enabling an interchange of the air in the heat element containing space and the air on the outside of the casing.

According to the invention, the temperature rise in the heat element containing space can be inhibited so as not to affect the operation of the main bimetal.

In addition, the thermal overload relay according to the invention is provided with vents on both of the side faces of the casing for enabling an interchange of the air in the contact switching mechanism containing space and the air on the outside of the casing.

According to the invention, the temperature rise in the contact switching mechanism containing space can be inhibited so as not to affect the operations of the switching mechanism and the contact changeover mechanism.

Moreover, in the thermal overload relay according to the invention, each of the vents is made to have a ventilation structure in which an opening formed in the casing has a plurality of first bars extendedly provided in parallel with one another at specified intervals so as to partly shut the opening and, in a position on the inside of the casing at a specified distance apart from a plurality of the first bars, a plurality of second bars are extendedly provided in parallel with one another at specified intervals. In the ventilation structure, the first bars and the second bars are alternately arranged so that one first bar blocks a gap between adjacent second bars and one second bar blocks a gap between adjacent first bars 15b.

According to the invention, ventilation of the air on the inside and the outside of the casing can be ensured and, along with this, the casing can be prevented from foreign matter entering into it.

Furthermore, the thermal overload relay according to the invention has on the upper face cover of the casing an operation indication and manual trip operation window formed through which window the contact changeover mechanism can be manually changed over and the operation of the contact changeover mechanism can be recognized. The peripheral wall of the opening of the operation indication and manual trip operation window is formed as an inclined surface with an inclination ascending from the bottom part of the peripheral wall in the direction away from the opening.

According to the invention, the region within which a worker can observe the operation indication and manual trip operation window becomes enlarged to allow the worker to easily recognize the operation of the contact changeover mechanism.

According to the invention, in the thermal overload relay, the upper face cover of the thermal overload relay mounted on a wall assumes a state of facing a worker carrying out wiring work of connecting the thermal overload relay to an electric load device. In this state, the auxiliary circuit terminals are arranged at positions different from the positions of the main circuit terminals are aligned. Thus, a distinction in visual angle is clearly established between the circuits of the main circuit terminals and the circuits of the auxiliary circuit terminals. Therefore, improper wiring wherein a worker carries out wiring work, which is to be made on the main circuit terminals for connecting an electric load device, erroneously on terminals other than the main circuit terminals, can be securely avoided.

### BRIEF DESCRIPTION OF THE DRAWINGS

FIG. 1 is a perspective view showing an external appearance of a thermal overload relay according to an embodiment of the invention as seen from a side provided with load side main circuit terminals and auxiliary circuit terminals;

FIG. 2 is a perspective view showing an external appearance of the thermal overload relay according to the embodiment of the invention as seen from the side with connecting wires connected to an electromagnetic contactor;

FIG. 3 is a top view showing the thermal overload relay according to the embodiment of the invention;

FIG. 4 is a perspective view showing the thermal overload relay according to the embodiment of the invention with a side cover removed;

FIG. 5 is a perspective view showing the main part of the contact changeover mechanism in the thermal overload relay according to the embodiment of the invention;

FIG. 6 is a cross sectional view taken along the line 6-6 in FIG. 3;

FIG. 7 is an enlarged view showing an auxiliary circuit terminal display formed on the upper face cover of the thermal overload relay according to the embodiment of the invention;

FIG. 8 is a cross sectional view taken along the line 8-8 in FIG. 3; and

FIG. 9 is a plan view showing an external appearance of a related thermal overload relay.

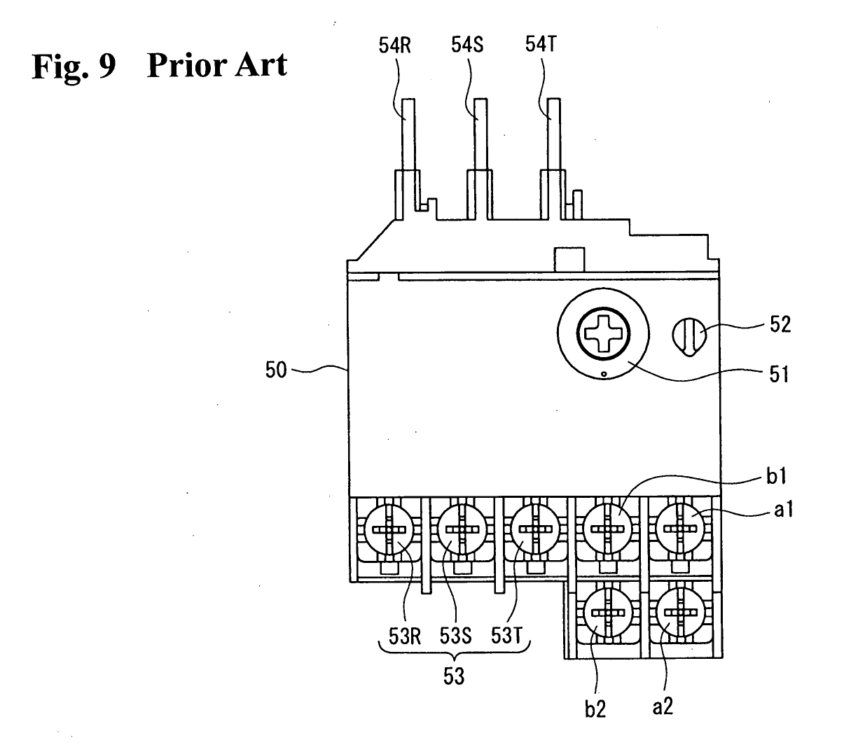

### DETAILED DESCRIPTION OF PREFERRED EMBODIMENTS

In the following, an embodiment for carrying out the invention (hereinafter referred to as an embodiment) will be explained in detail with reference to the attached drawings.

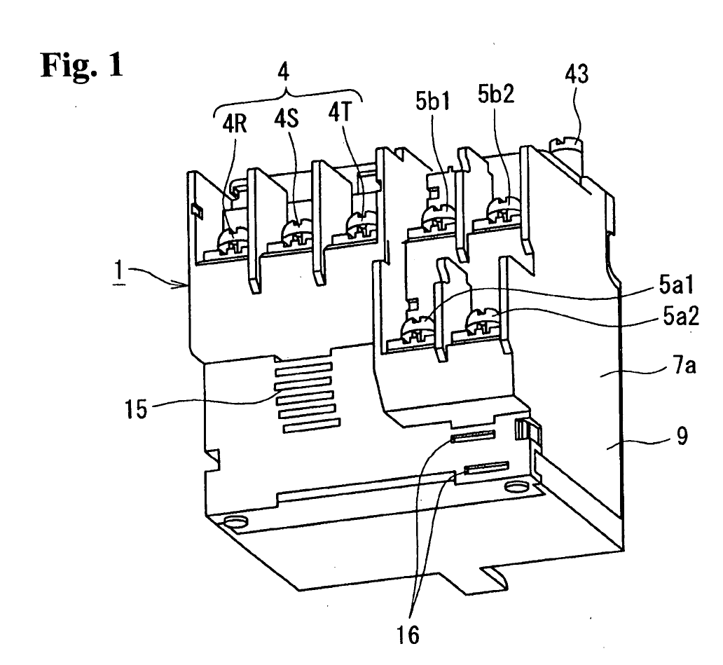

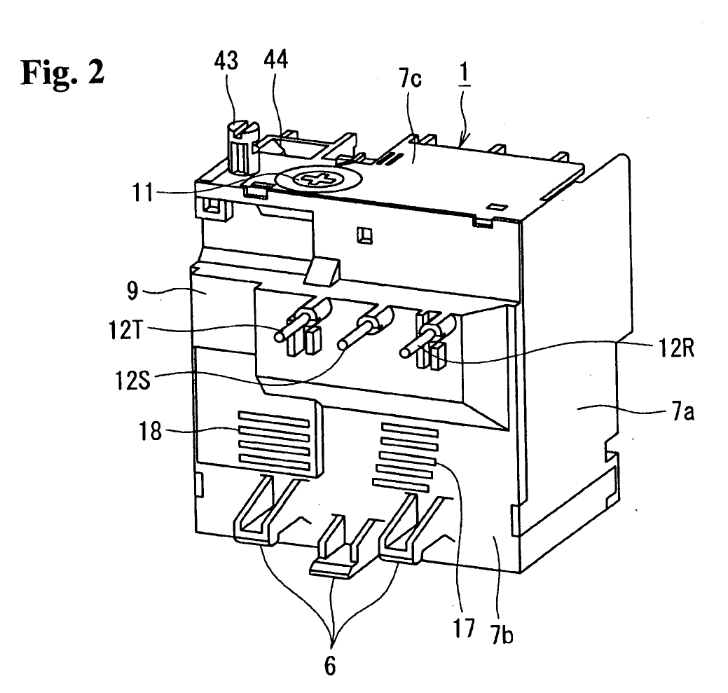

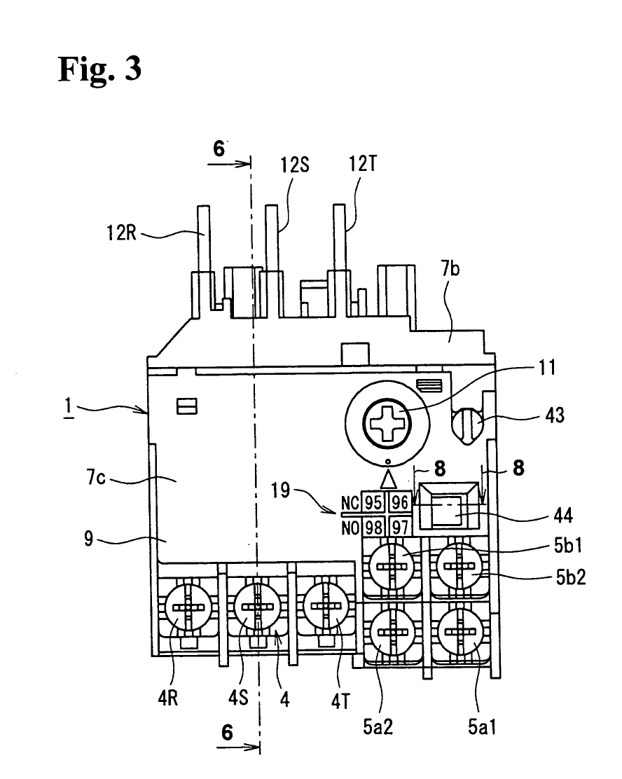

FIG. 1 is a perspective view showing an external appearance of the thermal overload relay according to an embodiment of the invention as seen from the side provided with load side main circuit terminals and auxiliary circuit terminals, FIG. 2 is a perspective view showing an external appearance of the thermal overload relay according the embodiment of the invention as seen from the side with connecting wires connected to an electromagnetic contactor and FIG. 3 is a top view showing the thermal overload relay according to the embodiment of the invention.

As shown in FIG. 1 to FIG. 3, a thermal overload relay 1 is provided with a casing 9 including a cubic insulation case 7a, a side cover 7b attached to an opening opened on the side of the insulation case 7a and an upper face cover 7c of the insulation case 7a.

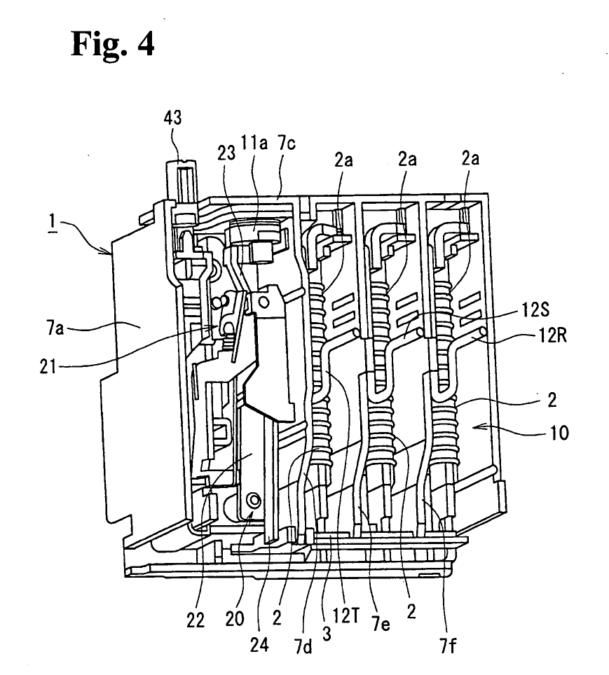

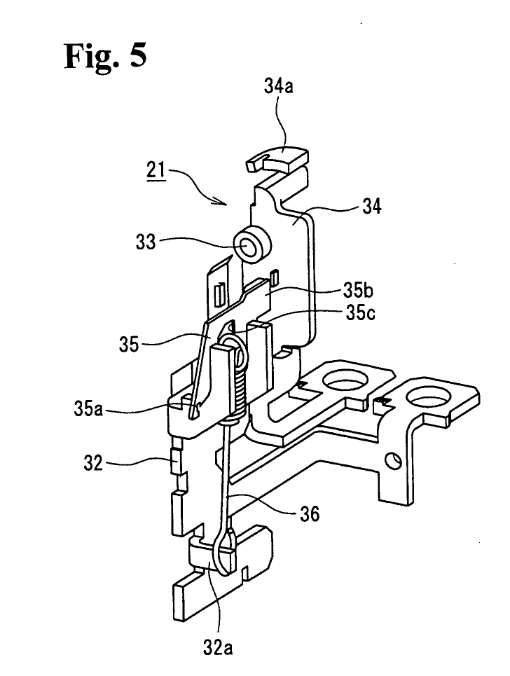

As shown in FIG. 2 and FIG. 3, on the upper face cover 7c, a resetting rod 43 is provided so as to project therefrom for resetting a contact changeover mechanism 21 that will be explained later with reference to FIG. 4 and FIG. 5, an adjusting dial 11 is provided for adjusting a switching mechanism 20 shown in FIG. 4 and, along with this, an operation indication and manual trip operation window 44 is provided.

As shown in FIG. 1, on one side of the casing 9 (the insulation case 7a), load side main circuit terminals 4 are provided which are electrically connected to a three-phase motor (electric load device not shown). The load side main circuit terminals 4 are an R-phase terminal 4R, an S-phase terminal 4S and a T-phase terminal 4T arranged in line at the same height.

At positions adjacent to the load side main circuit terminals 4, there are provided first auxiliary circuit terminals 5b1 and 5b2 each with a normally closed contact and second auxiliary circuit terminals 5a1 and 5a2 each with a normally open contact. The first auxiliary circuit terminals 5b1 and 5b2 are arranged in line at approximately the same height as that of the of the load side main circuit terminals 4. The second auxiliary circuit terminals 5a1 and 5a2, while being arranged at a height below that of the first auxiliary circuit terminals 5b1 and 5b2, are arranged in line in the same direction as that in which the first auxiliary circuit terminals 5b1 and 5b2 are extended. In general, the first auxiliary circuit terminals 5b1 and 5b2 each with a normally closed contact are electrically connected to terminals of the coil of an electromagnet of an electromagnetic contactor connected to the thermal overload relay 1.

As shown in FIG. 3, when viewed from the upper face cover 7c side, to the positions at which the R-phase terminal 4R, the S-phase terminal 4S and the T-phase terminal 4T of the load side main circuit terminals 4 are arranged, the first auxiliary circuit terminals 5b1 and 5b2 are at positions a little toward the adjusting dial 11 with a terminal arrangement different from that of the load side main circuit terminals 4 (not on the line of the load side main circuit terminals 4), and the second auxiliary circuit terminals 5a1 and 5a2 are also at positions distant from the positions of the adjusting dial 11 with a terminal arrangement shifted from that of the load side main circuit terminals 4 (not on the line of the load side main circuit terminals 4).

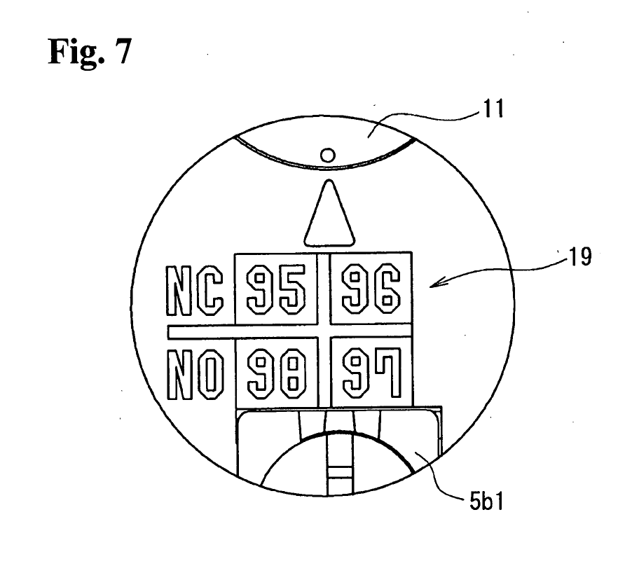

In the vicinity of the first auxiliary circuit terminals 5b1 and 5b2 on the upper face cover 7c, an auxiliary circuit terminal display 19 is formed which indicates the arranged positions of the first auxiliary circuit terminals 5b1 and 5b2 and the second auxiliary circuit terminals 5a1 and 5a2 as shown in FIG. 3 and FIG. 7, an enlarged view showing the auxiliary circuit terminal display 19 formed on the upper face cover 7c of the thermal overload relay 1. In the auxiliary circuit terminal display 19, alphabetical letters “NC” are formed for indicating that the normally closed first auxiliary circuit terminals 5b1 and 5b2 are at positions a little toward the adjusting dial 11 side and alphabetical letters “NO” are formed for indicating that the second auxiliary circuit terminals 5a1 and 5a2 are at positions distant from the adjusting dial 11 side. Along with this, numerals “95” and “96” are formed for indicating the types and the positions of the first auxiliary circuit terminals 5b1 and 5b2 and numerals “98” and “97” are formed for indicating the types and the positions of the second auxiliary circuit terminals 5a1 and 5a2.

Moreover, as shown in FIG. 2, on the side cover 7b attached onto the other side of the casing 9 (the insulation case 7a), three terminals of an R-phase power supply side terminal 12R, an S-phase power supply side terminal 12S and a T-phase power supply side terminal 12T are provided so as to project therefrom for connecting the thermal overload relay 1 to an electromagnetic contactor (not shown). On the side cover 7b, connecting legs 6 are provided which is made engaged with the electromagnetic contactor when the thermal overload relay 1 is attached to an electromagnetic contactor.

FIG. 4 is a perspective view showing the thermal overload relay 1 as an embodiment according to the invention with a side cover 7b being removed.

As shown in FIG. 4, in the insulation case 7a, there are provided an actuator mechanism 10 utilizing bending deformation due to temperature rise of three main bimetals 2 for three phases, respectively, the switching mechanism 20 moved by following the shift of a shifter 3 engaged with the main bimetals 2, the contact changeover mechanism 21 in which contacts are made changed over by the operation of the switching mechanism 20 and the resetting rod 43 for resetting the contact changeover mechanism 21.

Furthermore, in the insulation case 7a, a partition 7d is formed. A space provided on the right side of the partition 7d and containing the actuator mechanism 10 is to be referred to as a heat element containing space, and a space provided on the left side of the partition 7d and containing the switching mechanism 20 and the contact changeover mechanism 21 is to be referred to as a contact switching mechanism containing space.

The actuator mechanism 10 is provided with the three main bimetals 2, three heaters 2a of conductive material spirally wound around the three main bimetals 2, respectively, and the above explained shifter 3 engaged with the open ends of the three main bimetals 2. The three heaters 2a wound around their respective main bimetals 2 are connected, respectively, to the electrical connection section between the R-phase terminal 4R and the R-phase power supply side terminal 12R, the electrical connection section between the S-phase terminal 4S and the S-phase power supply side terminal 12S and the electrical connection section between the T-phase terminal 4T and the T-phase power supply side terminal 12T. Each heater 2a generates heat the quantity of which corresponds to the amount of current flowing in its own electrical connection section. Moreover, the three bimetals 2 are contained in their respective individual spaces formed by partitions 7e and 7f formed in the heat element containing space in the insulation case 7a.

The switching mechanism 20 is provided with an adjusting link 22, a release lever 23 rotatably supported by the adjusting link 22 and a temperature compensation bimetal 24 secured to the release lever 23 to be made engaged with the shifter 3. The upper part of the release lever 23 butts against the peripheral surface of an eccentric cam 11a of the adjusting dial 11 (see FIG. 2 and FIG. 3) rotatably disposed on the upper face cover 7c.

FIG. 5 is a perspective view showing the main part of the contact changeover mechanism 21 in the thermal overload relay 1 as an embodiment according to the invention.

The contact changeover mechanism 21 is, as shown in FIG. 5, provided with a changeover mechanism support 32, a link plate 34, a movable plate 35 and a changeover spring 36. The link plate 34 is disposed in the vicinity of the changeover mechanism support 32 while being rotatably supported by a supporting shaft 33 provided on the inner wall of the insulation case 7a. The movable plate 35 has its upper part 35b made swayable with a point in its lower part 35a, which point butts against the changeover mechanism support 32, made to serve as a support. The changeover spring 36 is formed as a tension coil spring stretched between an engaging opening 35c provided on the upper part 35b side of the movable plate 35 and a spring support 32a provided in the changeover mechanism support 32 positioned under the lower part 35a of the movable plate 35.

At the top end of the link plate 34, a trip operation lever 34a is formed. The trip operation lever 34a can be observed through the above-explained operation indication and manual trip operation window 44 (see FIG. 3) formed on the upper face cover 7c. With a tool such as a screwdriver, inserted through the operation indication and manual trip operation window 44, so as to engage the trip operation lever 34a, the movable plate 35 can be turned through the link plate 34 in the direction of causing the thermal overload relay 1 to assume a tripped state.

The contact changeover mechanism 21 is provided with a fixed contact and a movable contact each with a normally open contact (a contact) and a fixed contact and a movable contact each with a normally closed contact (b contact). Electric information from the normally open contacts (a contacts) and normally closed contacts (b contacts) is transmitted to terminals of an electromagnetic coil of an electromagnetic contactor through the above-explained first auxiliary circuit terminals 5b1 and 5b2 with normally closed contacts, by which the electromagnetic contactor is operated to open so as to shut off an overload current in a main circuit.

While, as shown in FIG. 1, below the positions at which the load side main circuit terminals 4 are provided on the casing 9 (insulation case 7), a first heat element section vent 15 is formed which leads to the above-explained heat element containing space. Moreover, below the positions at which the second auxiliary circuit terminals 5a1 and 5a2 are provided, a first auxiliary circuit section vent 16 is formed which leads to the above-explained contact switching mechanism containing space.

In addition, as shown in FIG. 2, also on the side cover 7b, there are formed a second heat element section vent 17 which leads to the heat element containing space and a second auxiliary circuit section vent 18 which leads to the contact switching mechanism containing space.

Here in detail, the first heat element section vent 15 and the second heat element section vent 17 lead to the heat element containing space between the partition 7e and the partition 7f shown in FIG. 4 (the space containing the main bimetal 2 and the heater 2a which are provided between the S-phase terminal 4S and the S-phase power supply side terminal 12S to be connected to them).

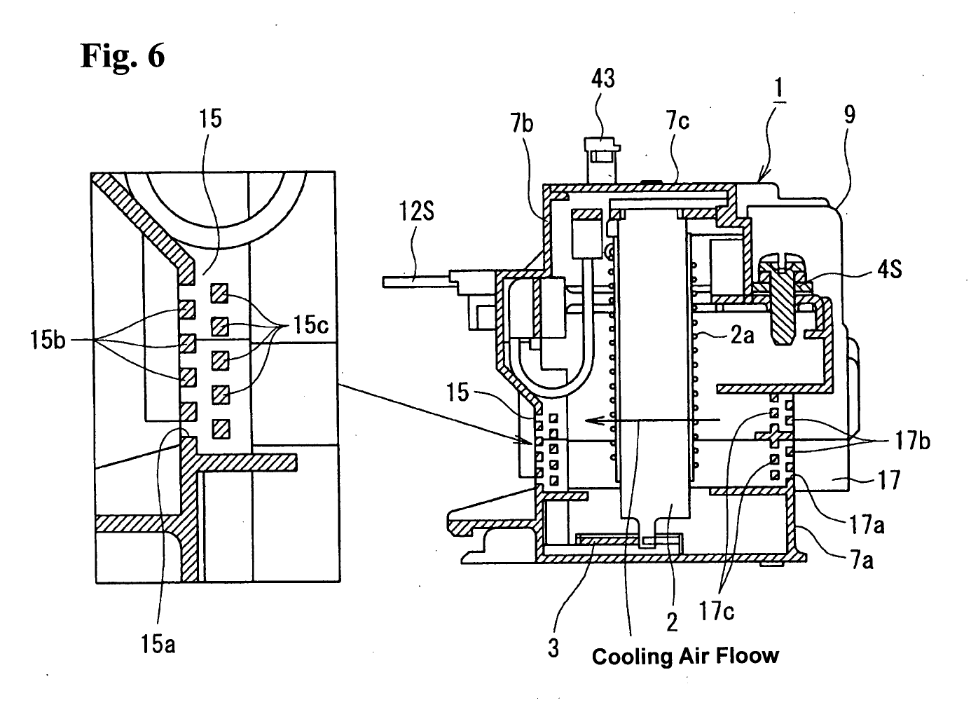

FIG. 6 is a cross sectional view taken along the line 6-6 in FIG. 3.

The first heat element section vent 15, as shown in FIG. 6, is constructed so as to have a ventilation structure in which a large opening 15a, formed in the casing 9 and leading to the heat element containing space, has a plurality of first bars 15b extendedly provided in parallel with one another at specified intervals so as to partly shut the opening 15a and, in a position on the inside of the casing 9 at a specified distance apart from a plurality of the first bars 15b, a plurality of second bars 15c are extendedly provided in parallel with one another at specified intervals. In the ventilation structure, the first bars 15b and the second bars 15c are alternately arranged so that one first bar 15b blocks a gap between adjacent second bars 15c and one second bar 15c blocks a gap between adjacent first bars 15b.

The second heat element section vent 17, as shown in FIG. 6, is also made to have a ventilation structure in which a large opening 17a, formed in the casing 9 and leading to the heat element containing space, has a plurality of first bars 17b extendedly provided in parallel with one another at specified intervals so as to partly shut the opening 17a and, in a position on the inside of the casing 9 at a specified distance apart from a plurality of the first bars 17b, a plurality of second bars 17c are extendedly provided in parallel with one another at specified intervals. In the ventilation structure, the first bars 17b and the second bars 17c are alternately arranged so that one first bar 17b blocks a gap between adjacent second bars 17c and one second bar 17c blocks a gap between adjacent first bars 17b.

Although not shown in detail, the first auxiliary circuit section vent 16 and the second auxiliary circuit section vent 18 also have the same structures as those of the first heat element section vent 15 and the second heat element section vent 17, respectively.

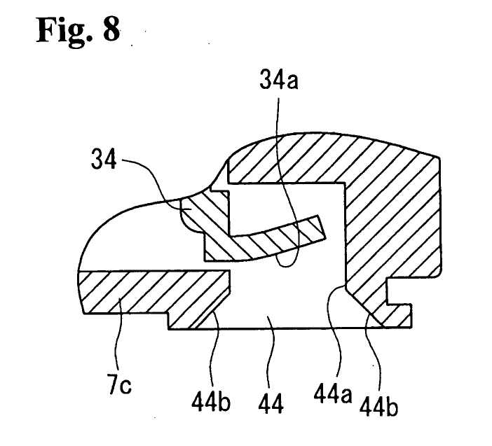

Moreover, the operation indication and manual trip operation window 44 provided on the upper face cover 7c shown in FIG. 3 is formed in a shape with which the trip operation lever 34a shown in FIG. 5 can be easily viewed. That is, as shown in FIG. 8, a cross sectional view taken in the direction of the arrows along the line 8-8 in FIG. 3, each of three of the four sides of a peripheral walls 44b, forming a rectangular opening 44a of the operation indication and manual trip operation window 44 with their bottom parts, is formed as an inclined surface with an inclination ascending from the bottom part of the peripheral wall 44b in the direction away from the opening 44a.

Next, the action and effect of the thermal overload relay 1 according to the embodiment will be explained.

The thermal overload relay 1 according to the embodiment is mounted on the wall with three of the R-phase power supply side terminal 12R, the S-phase power supply side terminal 12S and the T-phase power supply side terminal 12T electrically connected to an electromagnetic contactor. The thus mounted thermal overload relay 1 assumes a state as shown in FIG. 3 in which the upper face cover 7c faces a worker carrying out wiring work. In this state, wiring work is carried out for connecting the thermal overload relay 1 with a three-phase motor (electric load device).

In the thermal overload relay 1 according to the embodiment, when viewed from the upper face cover 7c side as shown in FIG. 3, to the terminal arrangement of the R-phase terminal 4R, the S-phase terminal 4S and the T-phase terminal 4T of the load side main circuit terminals 4, the terminal arrangement of the first auxiliary circuit terminals 5b1 and 5b2 is shifted upward and the terminal arrangement of the second auxiliary circuit terminals 5a1 and 5a2 is shifted downward. Therefore, a distinction in visual angle is clearly made among the circuit for the load side main circuit terminals 4, the circuit for the first auxiliary circuit terminals 5b1 and 5b2 and the circuit for the second auxiliary circuit terminals 5a1 and 5a2. Thus, it is possible to securely avoid improper wiring when a worker carries out wiring work, on the load side main circuit terminals 4 such as connecting a three-phase motor erroneously to terminals other than the load side main circuit terminals 4.

Moreover, in the thermal overload relay 1 according to the embodiment, the first auxiliary circuit terminals 5b1 and 5b2 with higher frequency of being used for connection with a device such as an electromagnetic contactor are at positions on the side of a worker (on the front side) to the positions of the second auxiliary circuit terminals 5a1 and 5a2. This facilitates the connection work at the first auxiliary circuit terminals 5b1 and 5b2 compared with the work at the related thermal overload relay.

In addition, in the vicinity of the first auxiliary circuit terminals 5b1 and 5b2 on the upper face cover 7c, an auxiliary circuit terminal display 19 is formed which indicates the terminal types and positions of the first auxiliary circuit terminals 5b1 and 5b2 and the second auxiliary circuit terminals 5a1 and 5a2. Thus, a worker can perform precise connection work between specified wires and terminals while observing the auxiliary circuit terminal display 19 on the upper face cover 7c.

Furthermore, the first heat element section vent 15 provided on one side of the casing 9 and the second heat element section vent 17 provided on the other side of the casing 9 lead to the heat element containing space.

Thus, as shown in FIG. 6, there is produced a flow of cooling air wherein the outside air enters the heat element containing space through, for example, the second heat element section vent 17 and is discharged from the first heat element section vent 15 after removing the heat in the heat element containing space. By the flow of the cooling air, the temperature rise in the heat element containing space due to heat generation of the heater 2a, wound around each of the three main bimetals 2, can be prevented so as not to affect the action of the main bimetals 2.

The first heat element section vent 15 and the second heat element section vent 17 particularly lead directly to the S-phase heat element containing space (the space between the partition 7e and the partition 7f) which is provided between the R-phase heat element containing space and the T-phase heat element containing space to be largely susceptible to the thermal influences of the spaces on both sides. Thus, in the thermal overload relay 1 according to this embodiment of the invention, the cooling effect in the S-phase heat element containing space is enhanced. Hence, the thermal influence on the space can be made reduced even though the thermal overload relay 1 is downsized.

Therefore, in the thermal overload relay 1 according to the embodiment, there is no need for particularly setting the amount of heat generation small for the heater 2a contained in the S-phase heat element containing space. This simplifies the mounting work of the heaters to make it possible to reduce manufacturing cost.

In addition, the first auxiliary circuit section vent 16 provided on one side of the casing 9 and the second heat element section vent 17 provided on the other side of the casing 9 lead to the contact switching mechanism containing space. Thus, there is produced a flow of cooling air wherein external air enters the contact switching mechanism containing space through, for example, the second auxiliary circuit section vent 18, and is discharged via the first auxiliary circuit section vent 16 after removing the heat in the contact switching mechanism containing space. By this flow of cooling air, a temperature rise in the contact switching mechanism containing space can be prevented so as not to affect the action of the temperature compensation bimetal 24.

The first heat element section vent 15 is formed to have a double layer structure with a plurality of the first bars 15b arranged directly in the casing 9 in parallel with one another at specified intervals and a plurality of the second bars 15c arranged in parallel with one another in a position on the inside of the casing 9 at a specified distance apart from a plurality of the first bars 15b. In the double layer structure, the first bars 15b and the second bars 15c are alternately arranged so that one first bar 15b blocks a gap between adjacent second bars 15c and one second bar 15c blocks a gap between adjacent first bars 15b. This can ensure ventilation of the air on the inside and the outside of the casing 9 and, along with this, prevent foreign matter from entering into the casing 9. Moreover, each of the second heat element section vent 17 and the first and second auxiliary circuit section vents 16 and 18 is made to have the same structure as above to make it possible to ensure ventilation of the air on the inside and the outside of the casing 9 and, along with this, to prevent foreign matter from entering into the casing 9.

Furthermore, in the operation indication and manual trip operation window 44 provided on the upper face cover 7c, each of three of the four sides of the peripheral walls 44b, surrounding the rectangular opening 44a with their bottom parts, is formed as an inclined surface with an inclination ascending from the bottom part of the peripheral wall 44b in the direction away from the opening 44a. Therefore, the region within which a worker can watch the operation indication and manual trip operation window 44 becomes enlarged. This allows easy recognition of the status of the trip operation lever 34a when the link plate 34 is in the initial state.

In the above embodiment, the operation indication and manual trip operation window 44 has each of three sides of the peripheral walls 44b, forming the rectangular opening 44a with their bottom parts, provided as an inclined surface. Compared with this, even with at least one of the four sides of the peripheral walls 44b provided as an inclined surface, the region within which a worker can observe the operation indication and manual trip operation window 44 becomes enlarged. Further, with all of the four sides of the peripheral walls 44b provided as inclined surfaces, the region within which a worker can observe the operation indication and manual trip operation window 44 can be made to become best enlarged.

While the present invention has been particularly shown and described with reference to the preferred embodiment thereof, it will be understood by those skilled in the art that the foregoing and other changes in form and details can be made therein without departing from the spirit and scope of the present invention.

The disclosure of Japanese Patent Application No. 2009-079398 filed on Mar. 27, 2009 is incorporated as a reference.

While the invention has been explained with reference to the specific embodiments of the invention, the explanation is illustrative and the invention is limited only by the appended claims.

What is claimed is:

1. A thermal overload relay comprising:
an actuator mechanism that generates an operating force by bending of a main bimetal with a heating wire wound thereon;
a switching mechanism that is driven by the operating force from the actuator mechanism;
a contact changeover mechanism wherein contacts are changed over by the operation of the switching mechanism; and
a casing that contains the actuator mechanism, the switching mechanism and the contact changeover mechanism, the casing having main circuit terminals and auxiliary circuit terminals arranged on its one side, the main circuit terminals electrically connecting the thermal overload relay to an electric load device, and the auxiliary circuit terminals electrically connecting the thermal overload relay to another electric device,
wherein when the casing is viewed from an upper face cover side, the main circuit terminals are aligned and, the auxiliary circuit terminals are arranged in a position offset from the position of the alignment of the main circuit terminals.

2. The thermal overload relay according to claim 1, wherein the auxiliary circuit terminals includes first auxiliary circuit terminals with normally closed contacts and second auxiliary circuit terminals with normally open contacts, and when the casing is viewed from a side, the first auxiliary circuit terminals with normally closed contacts are arranged in upper positions of the second auxiliary circuit terminals with normally open contacts.

3. The thermal overload relay according to claim 1, further comprising an auxiliary circuit terminal display for indicating the terminal types and positions of the auxiliary circuit terminals, which is formed on the upper face cover of the casing in a vicinity of the auxiliary circuit terminals.

4. The thermal overload relay according to claim 1, wherein a heat element containing space for containing the actuator mechanism having the main bimetal with a heating wire wound thereon and a contact switching mechanism containing space containing the switching mechanism and the contact changeover mechanism are disposed within the casing, and vents for enabling an interchange of air in the heat element containing space and air outside the casing are formed on both of the side faces of the casing.

5. The thermal overload relay according to claim. 1, wherein vents for enabling an interchange of air in the contact switching mechanism containing space and air outside the casing are formed on both side faces of the casing.

6. The thermal overload relay according to claim 4, wherein each of the vents has a ventilation structure in which an opening formed in the casing has a plurality of first bars extendedly provided in parallel with one another at specified intervals so as to partly shut the opening and, in a position on the inside of the casing at a specified distance apart from a plurality of the first bars, a plurality of second bars which are extendedly provided in parallel with one another at specified intervals, and the first bars and the second bars are alternately arranged so that one first bar blocks a gap between adjacent second bars and one second bar blocks a gap between adjacent first bars.

7. The thermal overload relay according to claim 1, wherein an operation indication and manual trip operation window, through which the contact changeover mechanism can be manually changed over and operation of the contact changeover mechanism can be recognized, is formed on the upper face cover of the casing, and
wherein a peripheral wall of the opening of the operation indication and manual trip operation window, has an inclined surface with an inclination ascending from the bottom part of the peripheral wall in the direction away from the opening.
